(19) United States
(12) Patent Application Publication
(10) Pub. No.: US 2003/0130015 A1
(43) Pub. Date: Jul. 10, 2003

(54) Paper printed radio

(76) Inventor: Stephen I. McTaggart, Atascadero, CA (US)

Correspondence Address: STEPTOE & JOHNSON LLP, 1330 Connecticut Avenue, N.W., Washington, DC, 20036, US

(21) Appl. No.: 10/040,947

(22) Filed: Jan. 9, 2002

(51) Int. Cl. H04B 1/38

(52) U.S. Cl. 455/569; 455/568

(57) ABSTRACT

A printed radio is disclosed. The radio is preferably part of a wearable hat, which has an earphone for listening by a user. The radio uses a printed antenna having substantial length enclosed in a relatively small area.

### BACKGROUND OF THE INVENTION

1. Field of the Invention

The present invention relates to a radio that is entirely mounted on flexible non-conductive surface. More particularly, the present invention relates to a radio in which all or some of the circuit components are printed onto a paper or cardboard surface.

2. Discussion of Background Information

The structure and operation of radios are well known. The circuitry and layout of radios has not been made sufficiently inexpensive such that radios can be dispensed for inexpensive purposes, such as novelty items.

### SUMMARY OF THE INVENTION

According to a preferred embodiment, a wearable radio configured to be used with a hat is provided. The wearable radio includes a flexible laminate capable of at least partially encircling the head of a user. The flexible laminate bears a radio circuit and a printed antenna. The printed antenna is configured on the laminate to have a length of at least about 5 feet. The wearable radio also includes a power source effective to power the radio circuit and an earphone connected to the radio circuit.

Various optional and preferable features of the above embodiment include that the radio circuit is limited to receiving a single frequency. Preferably the wearable radio further includes a hat associated with the laminate. Alternately, the wearable radio further includes a hat attached to the laminate. Preferably, the wearable radio has the radio circuit substantially printed on the laminate. Also preferable is that a hat associated with the laminate is positioned such that the earphone extends below an ear section of the hat. The printed antenna preferably occupies less than about 70 cm² of area of the printed laminate. The printed antenna also preferably occupies an area on the printed laminate that is less than about 14 cm² per foot length of the antenna. The power source of the wearable radio is preferably at least one of a printed battery and a solar cell. Preferably, the power source includes at least a solar cell positioned at one of a top of the hat and a lip of the hat. Also preferable is that the radio circuit includes at least one printed resistor or at least one printed capacitor. The wearable radio preferably has an antenna that is at least partially one of zig-zag, back-and-forth, and spiral.

According to another preferred embodiment, a wearable radio is provided. The wearable radio includes a flexible sheet of paper and a printed antenna printed on the flexible sheet of paper. The printed antenna is configured on the flexible sheet of paper to have a length of at least about 5 feet and an area of less than about 14 cm² per foot length of the antenna. A printed power source is printed on the flexible sheet of paper. Radio circuitry including a printed circuit pattern that connects the printed antenna, the printed power source, and circuit elements of the radio circuitry are on the flexible sheet of paper. A speaker element connects to the radio circuitry.

Various optional and preferable features of the above embodiment include that the radio circuitry is limited to a receiving a single radio frequency and that the speaker element is a printed speaker. Alternately, the speaker element may be an earphone.

According to another preferred embodiment, a wearable radio including a flexible and foldable substrate and radio circuitry on the substrate is provided. A printed antenna is printed on the substrate, the printed antenna being configured on the substrate to have an area of less than about 14 cm² per foot length of the antenna. The antenna is sufficient to receive a transmission at a venue having an associated transmitter. The radio circuitry includes a printed circuit pattern that connects the printed antenna and circuit elements of the radio circuitry. The wearable radio includes a power source effective to power the radio circuit and at least one of a speaker element and an earphone connected to the radio circuitry.

Various optional and preferable features of the above embodiment include that the radio circuit is limited to receiving a single frequency and that the printed antenna is less than about 5 feet in length. The power source is preferably at least one of a printed battery and a solar cell. The radio circuit preferably includes at least one printed resistor or at least one printed capacitor.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates the structure of the preferred embodiment of the invention.

FIG. 2 illustrates the circuit schematic of the preferred embodiment of the invention.

FIG. 3 illustrates a printed battery for use in the preferred embodiment.

FIG. 4 illustrates an embodiment of the present invention on a laminate configured for use in a hat.

FIG. 5 is a top view of the laminate of FIG. 4 associated with a hat.

FIG. 6 is a side view of the laminate of FIG. 4 associated with a hat.

FIG. 7 is a cross-section of an alternate printed battery embodiment.

FIG. 8 is a cross-section of a piezo-electric speaker.

FIG. 9 is a cross-section of a printed speaker employing a permanent magnet.

FIG. 10 is a cross-section of a printed speaker employing two coils.

FIG. 11 illustrates a printed speaker coil.

FIG. 12 illustrates a printed speaker coil particularly suited as a driver coil.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

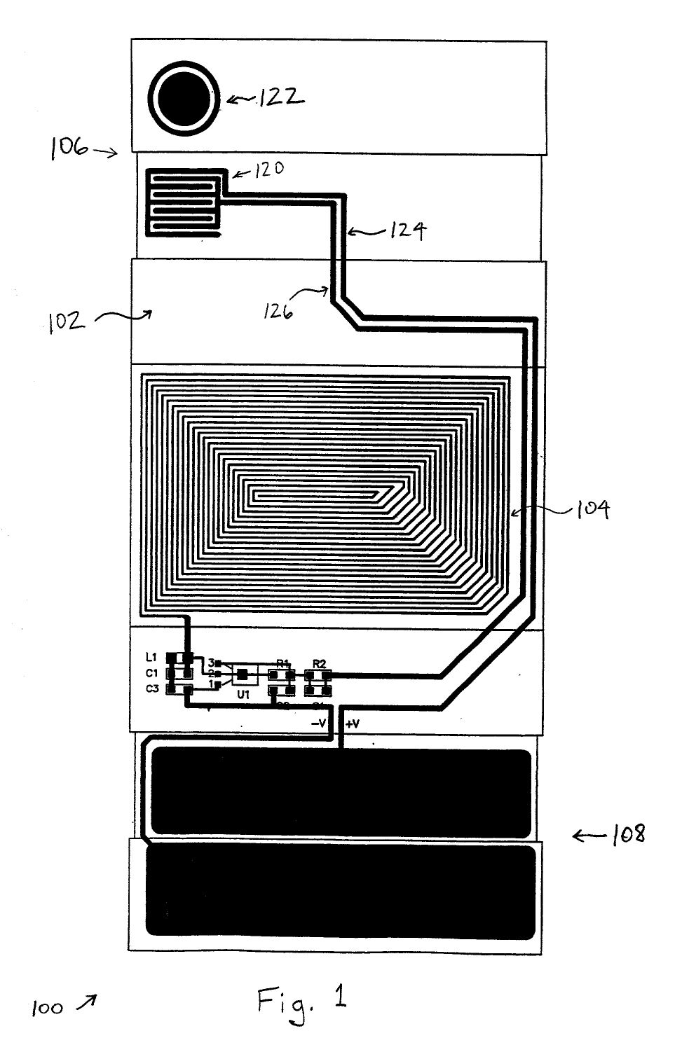

FIG. 1 illustrates an embodiment of a radio 100 that is at least partially printed on a flexible laminate 102. Laminate 102 is preferably made from a flexible and foldable material. Mylar paper and cardboard are non-limiting examples of appropriate materials for laminate 102. The printed wiring is preferably dried G.C.M PTF 10, which has flexible properties ideal for printing on a Mylar laminate.

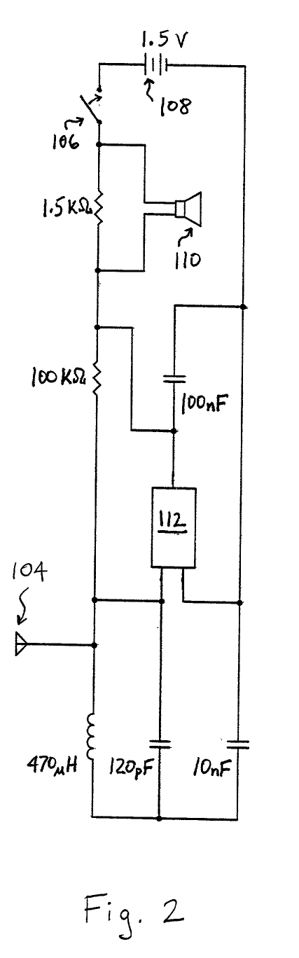

FIG. 2 illustrates the schematic of the radio circuit, including preferred values for the circuit elements. All of the wiring and an antenna 104 are preferably printed onto the laminate 102 with conductive ink. The remaining circuit elements may be printed using appropriate techniques, surface mounted off the shelf items, or various combinations thereof.

Referring now back to FIG. 1, antenna 104 must have sufficient length to receive radio broadcasts. For ballparks or arenas, in which the transmitter may be a few hundred feet from the seats in the ballpark, a printed antenna 104 having a thickness of 2-3 mm and a length of 5-6 feet has produced adequate reception at any seat in the ballpark. The antenna may be tailored for a particular venue, or for a particular type of venue. In particular, a venue may have a transmitter associated therewith, and the antenna may be tailored to the strength of the transmitter and the geometry and dimensions of the venue. In the alternative, the length may be sufficient to generally operate within the similar conditions of similar venues such as ballparks, arenas, or amphitheaters. Depending on the venue and the associated transmitter, some experimentation may be necessary to determine the length or dimensions a suitable antenna. Antenna 104 is printed onto laminate 102 in a pattern configured to make use of the available space to obtain such length. FIG. 1 shows a generally spiral antenna. Other configurations, such as back and forth or zig-zag may be used. In addition, the antenna path may be printed on both sides of laminate 102 to further avail itself of space. The abrupt turns in the antenna may be modified to have smooth curves in order to minimize noise.

As discussed herein, many printed components of radio 100 can be formed by folding over printed circuit sections. Any such folding should not bring any conductive materials into contact with the pattern that defines antenna 104. Such contact would short the antenna path and thereby “reduce” the effective length of antenna 104. However, this may not be an issue if the printed antenna is sealed or covered with an insulating film.

The radio receiver chip of the circuit of radio 100 is preferably limited or fixed to a single radio station. Such single station operation is attractive for many environments, such as a ballpark for listening to a corresponding broadcast of a baseball game. Another environment currently being discussed with the U.S. government is to airdrop such radios into war zones to allow people on the ground to receive broadcasts from U.S. sponsored sources, without providing radio access to other sources. Other numbers of stations are also possible. In particular, a printed radio capable of receiving any finite number of stations is contemplated.

As noted above, radio 100 includes printed circuit connections and a printed antenna 104. The remaining circuit elements, including an ON/OFF switch 106, a battery 108 (shown unfolded), an earphone 110, a radio receiver 112 and the various resistors, capacitors, inductors may either be printed circuit elements or surface mounted off-the-shelf items. The structure of surface mounted elements and the methodology for mounting them are well known, and not addressed further herein.

Preferably all of the electronic circuitry is between first and second layers of laminate 102, particularly between folded portions of a single larger prepared laminate. In the alternative, only certain portions of the underlying circuitry are covered or otherwise folded. As described below, the circuits are printed with conductive ink.

Radio 100 includes a printed ON/OFF switch 106. Switch 106 includes a first printed portion 120 and a second printed portion 122. First portion 120 has an interlaced printed contact surface area that connects to leading printed wires 124 and 126. Second printed portion 122 has a surface area configured as circle. First and second printed portions overlap such that contact between the two connects (via depression) shorts the electrical path between the two lead printed wires 124 and 126.

As this type of switch requires maintained depression to operate, an alternative is to use a printed, wire connected, or surface mounted switch that will stay in the ON or OFF position. In another alternative, the circuit could be designed to accept a “pulse” type ON and OFF command from depressing switch 106.

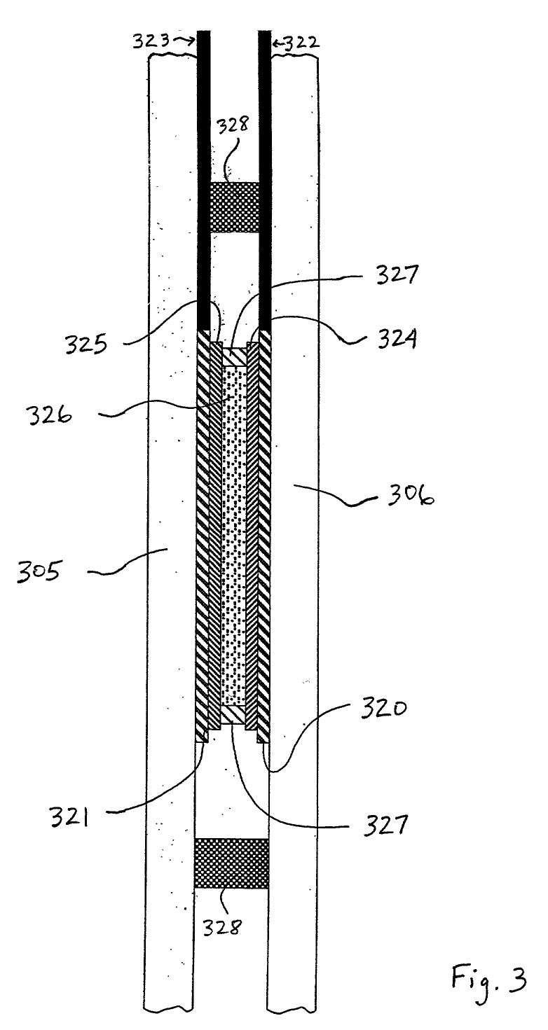

FIG. 3 illustrates a printed battery 110 for printed radio 100, which preferably is no more than 1.5 volts. The battery leads are shown as leading to the top of the page, rather than in their actual positions as shown in FIG. 1, as the placement of these leads is a routine part of the overall printed circuit layout. The upper and lower inner faces 305 and 306 are preferably folded over portions of laminate 102. These faces essentially form upper and lower substrates with the printed battery structure sandwiched therein. A lower electrically conductive portion 320 is printed on the lower inner face 306, and an upper electrically conductive portion 321 is printed on upper inner face 305. A negative electrode layer 324 is printed on the inner face of the lower electrically conductive portion 320, while a positive electrode layer 325 is printed on the inner face of the upper electrically conductive portion 305. A battery electrolyte 326 is applied and/or printed over either or both of negative electrode 324 and positive electrode 325. A container may be provided for the battery electrolyte. Positive lead 323 connects to upper electrically conductive portion 321, and negative lead 322 connects to lower electrically conductive portion 320. Printed support structure 327 contains an electrolyte, and a peripheral adhesive layer 328 encompasses the entire battery structure.

For some embodiments, a solar cell may supplement or replace battery 110. The solar cell may be a printed element on the laminate in combination with printed power lines on the laminate, a separate unit attached to the laminate and connected to the rest of the circuit by printed power lines, or a separate unit that connects to the laminate by wires.

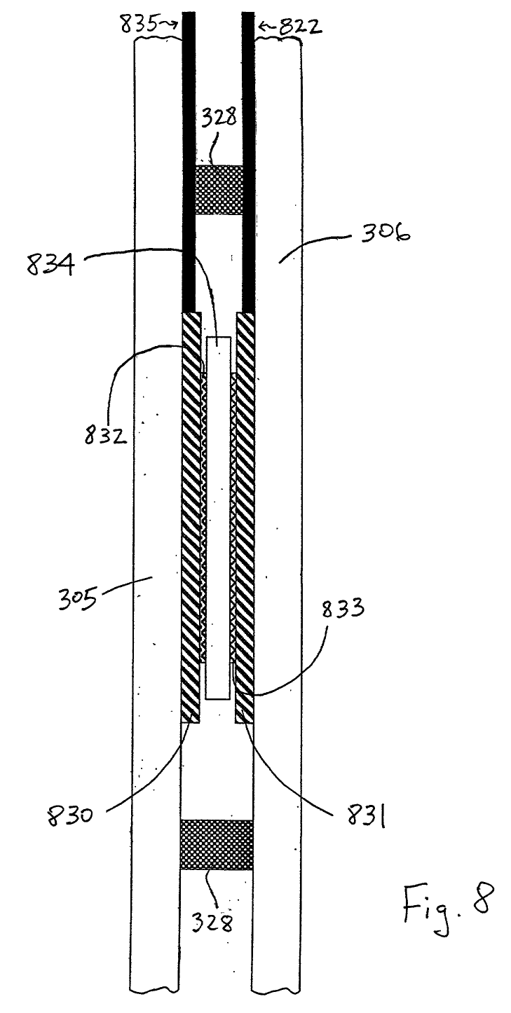

Various features may also be used in conjunction with the above embodiment. By way of non-limiting example, the earphone may be replaced with a printed speaker. Techniques for printing a speaker are disclosed below in reference to FIGS. 8-12. In the alternative, the speaker could be a surface mounted element.

In order to receive radio signals, the antenna must be of sufficient length relative to the proximity to the transmitter. For ballparks, in which the transmitter may be a few hundred feet from the seats in the ballpark, a printed antenna having a thickness of 2-3 mm and a length of 5-6 feet has resulted in adequate reception.

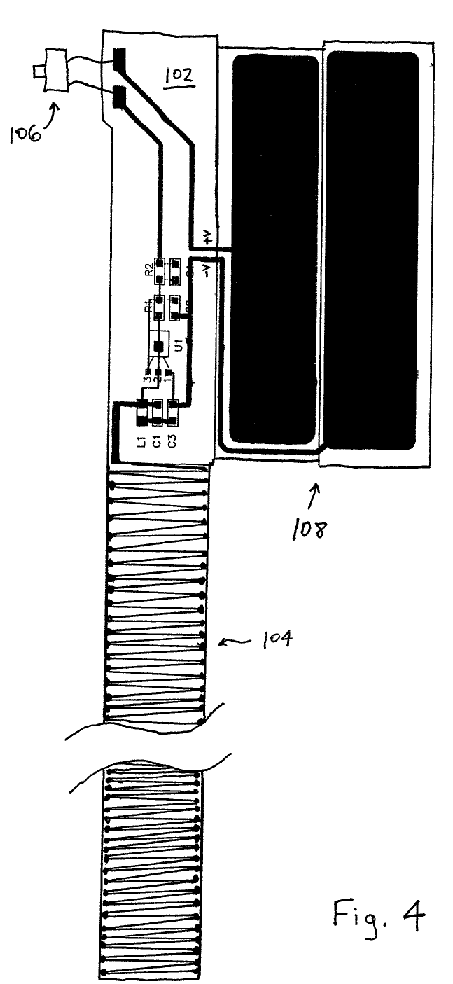

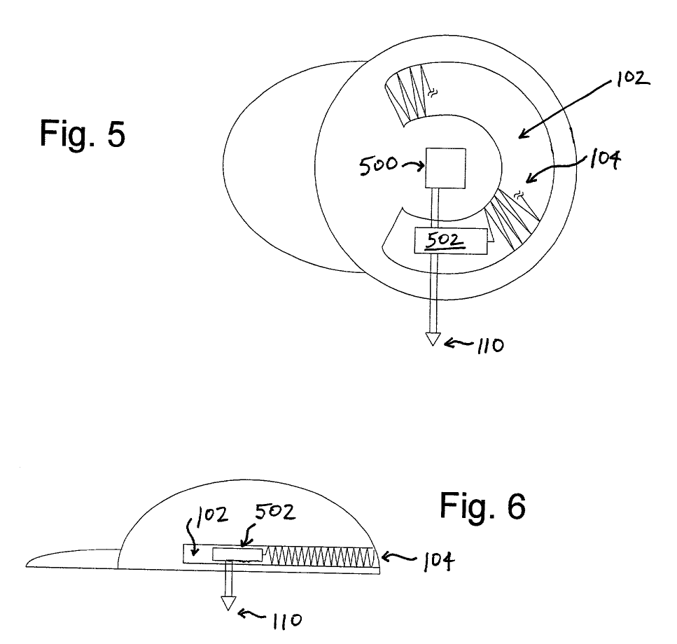

FIGS. 4-6 illustrate an embodiment of the present invention configured for use in a hat. In this embodiment, the laminate would have dimensions consistent with a band about the head (e.g., about 1 inch by 12 inches). The bulk of the laminate is taken up by the antenna, which in this embodiment is laid out in a zig-zag pattern (although any appropriate pattern as discussed above may be used). The edge of each intersection of lines that form the zig-zag is preferably expanded into a dot to prevent thin sections of the antenna path.

Circuitry 502 is also positioned on the laminate. Preferably, the laminate is positioned such that the speaker or earphone is proximate to the portion of the hat that would be adjacent a user's ear. The laminate may be on the outside of the hat, inside the hat, woven into the hat, or some combination thereof. The wires from the earphone 110 would be attached (preferably soldered) to the printed speaker lines adjacent the ear portion of the hat. The earphone would thus “hang” from the printed radio in the hat for a user to easily insert into the ear.

Various features may also be used in conjunction with the above embodiment. By way of non-limiting example, the earphone may be replaced with a speaker. Another feature that may be used is a solar cell to supplement or replace the internal battery. The solar cell is preferably positioned on the outside of the hat, and particularly on the top of the hat. The solar cell may be a printed element on the laminate in combination with printed power lines on the laminate, a separate unit attached to the laminate and connected to the rest of the circuit by printed power lines, or a separate unit that connects to the laminate by wires (similar to the earphone).

Preferably, the entire radio 100, including all of its elements, are printed, mounted, or connected to a single sheet of flexible laminate 102. The laminate may be flat, or partially or completely folded. The flexible laminate may be cut to any desirable shape to be folded as desired (subject to not shorting the antenna path). By way of non-limiting example, flaps could be added to flexible laminate 102 in FIG. 1 so as to fold into a box.

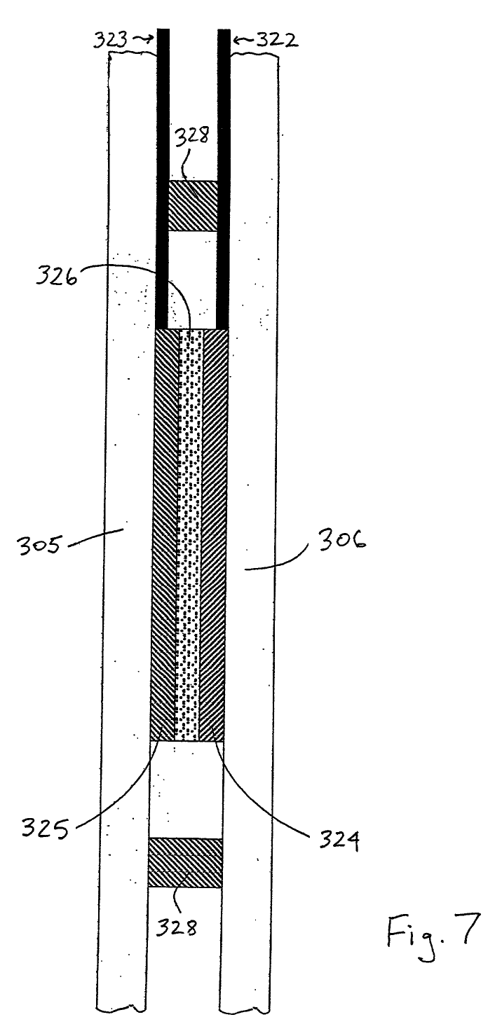

FIG. 7 illustrates an alternate printed battery embodiment. For some electrode materials, conductive pads 320, 321 are not necessary and may be omitted. In this embodiment, the positive electrode 325 is printed directly on the upper substrate 305 and connected to positive supply lead 323, and the negative electrode 324 is printed directly on the lower substrate 306 and connected directly to the negative supply lead 322. Factors in determining whether electrically conductive portions 320, 321 may be eliminated include: how well an electrode will print directly on substrates 305, 306, how well an electrode electrically and physically connects to printed leads 322, 323, and the physical strength of a given electrode. With some electrode combinations, it may be necessary to use an electrically conductive portion with one electrode, but not the other electrode, resulting in a four-layer battery structure between substrates 305, 306. Additionally, for some relatively small batteries with physically stable electrolyte gel, support 327 of the preferred embodiment may be omitted.

FIG. 8 illustrates a cross-section of a speaker used in the preferred embodiment. An upper conductive portion 830 is printed on the inner face of the substrate 305, and a corresponding lower conductive portion 831 is printed on the lower substrate 306. A layer of conductive adhesive 832 is then printed on the upper conductive portion 830, and a corresponding layer 833 of conductive adhesive is printed on the lower conductive portion 831. Finally, a piezoelectric element 834 is laid over one of the layers 832, 833 of conductive adhesive such that the piezo-electric speaker is completed when the inner faces are folded together and glued. A ring of adhesive 328 around the speaker structure serves both to insure the integrity of the assembled speaker and to stiffen the paper in the region of the speaker, which improves frequency response, clarity, and intelligibility of the audibly reproduced broadcast.

In the preferred embodiment, the lower conductive portion, and hence one side of the piezo-electric element 834, is electrically connected directly to the negative lead 822 from the battery via the conductive adhesive 833. The upper conductive portion 830, and hence the other side of the piezo-electric element, is electrically connected to the audio lead 835 via the conductive adhesive 832. The audio lead receives the audio input signal from the circuitry. Thus, the frequency signals from the circuit, which are referenced to the negative side of the battery, result in establishing corresponding movement of the piezo-electric 834 to obtain an audible signal. The piezo-electric element itself is not printed per se.

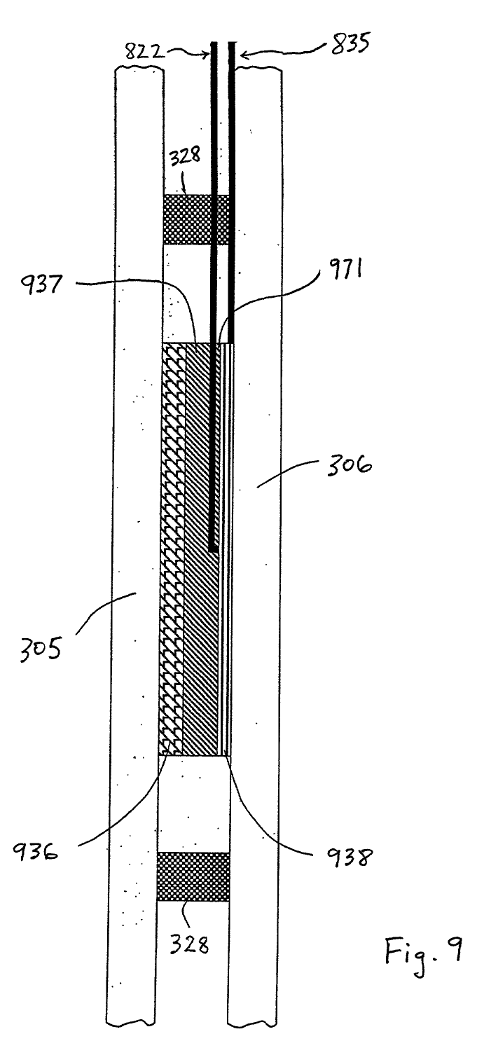

FIG. 9 illustrates a cross-section of an alternate speaker embodiment featuring a permanent magnet. In this embodiment, a permanent magnet 936 is printed on the upper substrate 305, and a printed coil 938 is printed on the lower substrate 306, the two being electrically insulated from one another by a printed insulation layer 937. The permanent magnet 936 establishes a magnetic field and the circuit drives printed coil via printed lead 935 with return path through the negative lead 822. The printed speaker thus responds to the audio signals by developing a correspondingly varying electromagnetic field that reacts with the permanent magnet's field to cause the coil and magnet to move with respect to one-another. The surrounding sheet material acts as a speaker cone, further defined by the stiffening function of the ring of adhesive 328.

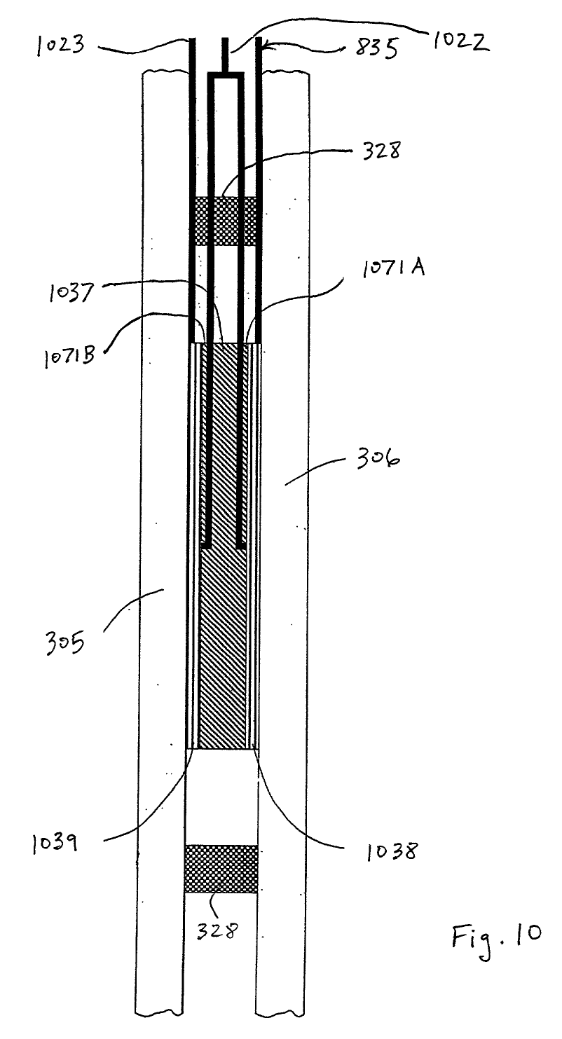

FIG. 10 is a cross-section of an alternate speaker embodiment using two printed coils. In this embodiment, a second coil is printed on the upper substrate and is selectively (e.g., conventionally by a switch, not shown) energized from the battery via printed conductors 1022, 1023, establishing the reference field for the varying field produced by the coil 1038.

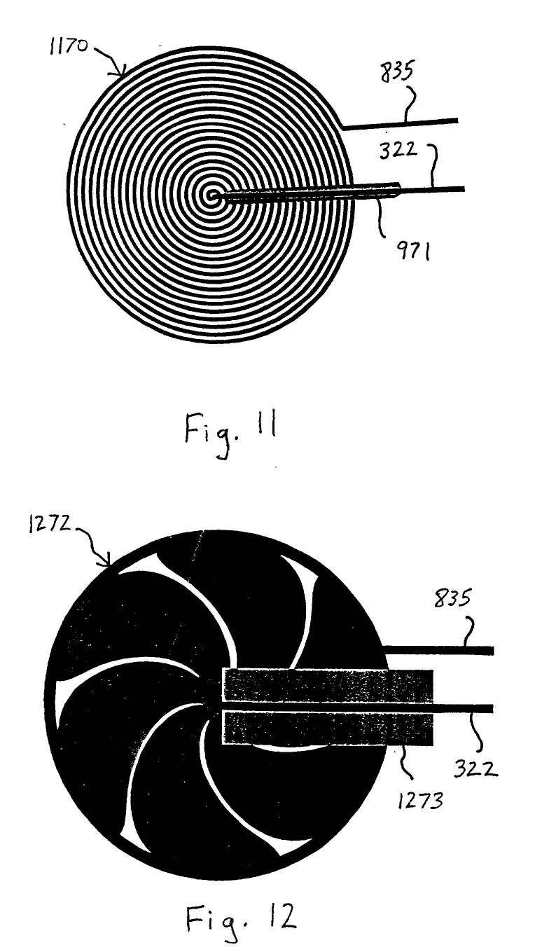

The printed coils 1038, 1039, which are electrically separated by printed insulation layer 1037, may take diverse configurations. Printed insulation 1071A, 1071B serves to insulate the line 1022 to the center of a spiral wound coil (e.g., 1170 in FIG. 11) from shorting out the windings.

FIGS. 11 and 12 show embodiments for printed speaker coils if an earphone is not used. The coil illustrated in FIG. 11 can be used as either the drive coil 1038 or the field coil 1039 (or both). FIG. 12 illustrates a fan-shaped coil 1272, driven at the edge and the center, which is particularly well-suited for use as the drive coil 1038. In order to connect the coupling conductor 835 to the center point of the fan-shaped coil 1272, an insulating pad 1273 is printed before the conductor 322 is laid down.

FIG. 3, along with FIGS. 7-10, illustrate layered structures in which the thicknesses of the individual layers are very much exaggerated for clarity in illustrating and explaining their cooperative relationships. Thus, those skilled in the art will understand that the thinness of each of the lamina in actual implementation is sufficient to provide completed battery and speaker components which are readily accommodated between a folded thin sheet (or two thin sheets) glued or otherwise fused to provide a laminated sheet, containing electronic circuitry, which is not inordinately thick for its intended purpose.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A wearable radio configured to be used with a hat, comprising:
a flexible laminate capable of at least partially encircling the head of a user;
said flexible laminate bearing thereon a radio circuit and a printed antenna,
said printed antenna being configured on said laminate to have a length of at least about 5 feet;
a power source effective to power said radio circuit; and
an earphone connected to said radio circuit.

2. The wearable radio of claim 1, wherein said radio circuit is limited to receiving a single frequency.

3. The wearable radio of claim 1 further comprising a hat associated with said laminate.

4. The wearable radio of claim 1 further comprising a hat attached to said laminate.

5. The wearable radio of claim 1 wherein said radio circuit is substantially printed on said laminate.

6. The wearable radio of claim 1 further comprising a hat associated with said laminate positioned such that said earphone extends below an ear section of said hat.

7. The wearable radio of claim 1, wherein said printed antenna is configured to occupy less than about 70 cm² of area of said printed laminate.

8. The wearable radio of claim 1, wherein said printed antenna is configured to occupy an area on said printed laminate that is less than about 14 cm² per foot length of said antenna.

9. The wearable radio of claim 1, wherein said power source is at least one of a printed battery and a solar cell.

10. The wearable radio of claim 1, wherein said power source includes at least a solar cell positioned at one of a top of said hat and a lip of said hat.

11. The wearable radio of claim 1, wherein said radio circuit includes at least one printed resistor.

12. The wearable radio of claim 1, wherein said radio circuit includes at least one printed capacitor.

13. The wearable radio of claim 1 wherein said antenna is at least partially one of zig-zag, back-and-forth, and spiral.

14. A wearable radio, comprising:
a flexible sheet of paper;
a printed antenna printed on said flexible sheet of paper, said printed antenna being configured on said flexible sheet of paper to have a length of at least about 5 feet and an area of less than about 14 cm² per foot length of said antenna;
a printed power source printed on said flexible sheet of paper;
radio circuitry on said flexible sheet of paper, said radio circuitry including a printed circuit pattern that connects said printed antenna, said printed power source, and circuit elements of said radio circuitry; and
a speaker element connected to said radio circuitry.

15. The wearable radio of claim 14, wherein said radio circuitry is limited to a receiving a single radio frequency.

16. The wearable radio of claim 14, wherein said speaker element is a printed speaker.

17. The wearable radio of claim 14, wherein said speaker element is an earphone.

18. A wearable radio, comprising:
a flexible and foldable substrate;
a printed antenna printed on said substrate, said printed antenna being configured on said substrate to have an area of less than about 14 cm² per foot length of said antenna, and said antenna being sufficient to receive a transmission at a venue having a transmitter associated therewith;
radio circuitry on said substrate, said radio circuitry including a printed circuit pattern that connects said printed antenna and circuit elements of said radio circuitry;
a power source effective to power said radio circuit; and
at least one of a speaker element and an earphone connected to said radio circuitry.

19. The wearable radio of claim 18, wherein said radio circuit is limited to receiving a single frequency.

20. The wearable radio of claim 18, wherein said printed antenna is less than about 5 feet in length.

21. The wearable radio of claim 18, wherein said power source is at least one of a printed battery and a solar cell.

22. The wearable radio of claim 18, wherein said radio circuit includes at least one printed resistor.

23. The wearable radio of claim 18, wherein said radio circuit includes at least one printed capacitor.
